(19) United States
(12) Patent Application Publication
(10) Pub. No.: US 2014/0111438 A1
(43) Pub. Date: Apr. 24, 2014

(54) SYSTEM, METHOD AND APPARATUS FOR THE TRANSCRIPTION OF DATA USING HUMAN OPTICAL CHARACTER MATCHING (HOCM)

(71) Applicant: Paul Savage, Alpine, UT (US)

(72) Inventor: Paul Savage, Alpine, UT (US)

(21) Appl. No.: 14/056,683

(22) Filed: Oct. 17, 2013

Related U.S. Application Data
(60) Provisional application No. 61/795,506, filed on Oct. 18, 2012.

(51) Int. Cl. G06F 3/023

(52) U.S. Cl. CPC G06F 3/0238
USPC 345/168

(57) ABSTRACT

The present invention describes a novel system, method and apparatus to acquire and make widely available data or information from the pre-digital age that was previously not widely accessible, or in some cases, not available at all except to highly trained specialists. The invention facilitates the use of Human Optical Character Matching, in place of computer-driven Optical Character Recognition, for use with documents and manuscripts where OCR cannot be applied effectively, while still realizing cost benefits comparable to OCR.

### FIELD OF INVENTION

The present invention describes a novel system, method and apparatus to acquire and make widely available data or information from the pre-digital age that was previously not widely accessible, or in some cases, not available at all except to highly trained specialists. The invention facilitates the use of Human Optical Character Matching, in place of computer-driven Optical Character Recognition, for use with documents and manuscripts where OCR cannot be applied effectively, while still realizing cost benefits comparable to OCR.

### BACKGROUND OF THE INVENTION

Ours is a society driven by data—by information. We generate more of it than ever before, increasingly through the use of information technology devices. People write new fiction and non-fiction using computers and publish them as ebooks; government officials and researchers gather data points using monitors and sensors; business people exchange personal information, write message, and view commercial media files through tablet computers, smart phones, and the like. But in addition to increasing ease of production of data, we expect convenient access to more of it than ever before.

Before current technologies were available, millions upon millions of pages of information were created in handwritten (or later, in other non-digital) formats. Examples include:
Vital records maintained by government entities and religious organizations
Personal journals
Legal records (including for real property, probate, civil and criminal disputes)
Immigration records
Personal papers of prominent individuals
Archives of letters
Tax records

Although a portion of these documents have been converted to a digital format via optical scanning technologies, most still have not. Some scanned images (such as those drawn from books and newspapers) may be further processed via Optical Character Recognition (OCR) technologies so that the contents of such documents are searchable via computer. That is, written words are converted to a computer-readable rasterized or bitmapped image—a series of dots. The image of each character within a document is then converted to a code that represents that character, in a manner that the character can be more easily stored and searched via computerized digital technologies. For example, a bitmapped image of the letter “A” may be converted in the ASCII encoding system to the number 65. Multiple codes converted from multiple images then form words or numeric data. Once converted in this manner, the data that was effectively inaccessible on a scanned page can be placed within a computer database or a computerized document. In this format, it can be searched, transmitted electronically, replicated, backed-up, and so forth. For example, an image that forms the word “Adam” within a document can be viewed on a computer screen, but if a user attempts to search for the word “Adam,” the computer cannot identify that image as containing that word. However, once converted into an encoded format using OCR technologies, the computer can locate information based on searches or other standard computerized operations.

In a typed manuscript, the subtle difference between and “l” and an “i” can be as simple as determining whether the character was dotted or not. After all, every i should be dotted and every t crossed. Yet, this minor ability plagues OCR systems, which generally cannot distinguish between dots and dust specks and between spaces left because of poor paper quality or low ink saturation and those spaces required by the formation of the character itself. Yet in most instances, (sometimes aided by only minimal enlargement of a character on a page) the human eye can easily tell the difference in any given situation. Despite the advances in OCR technology, the human brain's ability to determine which of these things is like or not like the other is still years ahead of any software functionality, and perhaps always will be for generations to come. Indeed, HOCM ability and its reliability over OCR forms the basis for CAPTCHAs (Completely Automated Public Turing test to tell Computers and Humans Apart), widespread security measures on the World Wide Web that prevent abuses by asking humans to perform a task that computers cannot yet perform, such as deciphering distorted characters. Thus, when applied to handwritten documents, the advantages of HOCM over OCR are exponential, but just as OCR depends largely on the quality of scanners or photographic inputs, HOCM depends on the quality of the keyboard characters and layout—whether the matching characters can be located with reasonable ease.

Existing OCR technologies cannot process older documents that are handwritten, whether in block-print or a cursive handwriting. Because of the inconsistencies in handwriting and the effects of age and discoloration or other damage on older documents (including paper degradation, ink “bleeding” or smearing, ink “bleed-through” due to paper porosity, ink fading, pest damage, etc.), OCR technologies are unable to consistently convert scanned images of handwritten documents in a format that would permit them to be searched within a computer document or computerized database with acceptable levels of accuracy. For example, if an OCR process results in a 90% accuracy rate for each character in a newspaper, the error rate compounds with each additional letter in a given word. If the average word length in a given newspaper article is five letters, then with each character error rate compounded, the error rate for the word drops to just under 60%. OCR processes for older handwritten documents do not presently come close to producing a 90% per character accuracy rate. Generally, older handwritten documents are far more problematic, even than modern handwritten documents; older handwritten documents may be written in a lettering style that is no longer used, or contain inconsistent or archaic spellings, abbreviations or terms. Thus, a modern human reader who could readily decipher a modern text or even an older book would still require specialized training to understand the letters and words within most older handwritten documents, and OCR technologies fare enough worse. These difficulties are compounded exponentially when documents contain texts in a foreign language.

Because of the problems associated with making handwritten documents accessible using traditional scanning and OCR technologies, documents that have great commercial, historical, or aesthetic value are less likely to be converted into a format that can be read, stored, and searched via computerized technologies than are printed materials. Thus, when researchers are desire to use handwritten documents in their original forms, the documents are subjected to additional degradation through additional handling, exposure to light and varied humidity, and exposure to contaminants (such as oils or other moisture from human contact).

Ultimately, because of the limitations of OCR technology, converting these problematic handwritten documents into usable digital texts requires human intervention. Traditionally, a person who is familiar with the language and style of handwriting used in a particular document will view the original document or a photocopy or a scanned, computer-based image of an original document. The person will then perform data entry that corresponds to the information that appears in the image. We call this process “human transcription.” For example, the computer may display an image containing the word “Adam.” A human operator familiar with these letters will type in the word “Adam.” In this manner, the meaning of the image is extracted and stored in a way that permits database searching, efficient storage, and other benefits. An analogous process occurs when a medical transcriptionist converts an audio recording of a physician speaking into a typed transcript of that recording. The audio recording contained all of the relevant information. But the transcriptionist deciphers the audio content and then converts the audio recording into a format that can be more easily stored, searched, index, collated, and used in ways that are not possible with the audio recording.

One example of human transcription of old documents—mostly handwritten—is Ancestry.Com's World Archives Project (See http://community.ancestry.com/awap.) In this project, volunteers use a software program that presents an image of an original document on screen. The volunteer reads the document and types in data that appears within the image related to the pre-defined fields sought to be indexed. Additional software tools create a correspondence between the original image and the data entered by the volunteer, so that a computerized search for a term that appears within the image will permit viewing of that image. Notwithstanding the possibility of using human transcription to convert original documents into computer-readable data formats, large scale human transcription of older materials still presents several significant obstacles using existing methodologies:

Obstacle 1. Persons engaged in human transcription may not be familiar with the handwriting variances presented in a document, and more particularly the variances found in a series of documents that were written by multiple scribes, including those associated with the changes to handwriting scripts over several centuries. For example, statistical sampling for indexing projects related to older German language documents showed characters were only “keyed” correctly about 50% of the time, with over 10% of the characters being skipped altogether; note that these statistics relate only to attempts at “indexing”, not complete transcriptions.

Obstacle 2. Persons engaged in human transcription may not be familiar with the language used in the documents that they are transcribing. When a transcriber understands the language of the document, it can be a tremendous aid in word recognition and thus increase the accuracy of letter and word renditions; on the other hand, it can also cause a transcriber to make improper inferences with respect to novel words, spelling variations, or to miss or omit other details that decrease the accuracy in literal transcriptions.

Obstacle 3. Persons engaged in human transcription may not be familiar with the facts that relate to the documents that they are transcribing, such as historical details, place names, common spellings of personal names, and persons or events associated with the information contained within the subject documents. This is even more significant when documents involve “free-form text” such as journals, correspondence, reports, minutes, or similarly unstructured content, in contrast to birth, marriage or death registers, church records for baptisms, membership rolls, census records, or the like. Whereas the transcription or indexing of the latter may be aided by creating data entry “fields” with predictive value concerning probable field or document content (such as predicting that the left column of a page will be a list of names), free-form text offers less opportunity for such fields.

Obstacle 4. Persons engaged in human transcription may not be familiar with archaic spelling variations, abbreviations, words or combinations of letters represented by symbols, etc. Historic differences in character formation that may be understood by experts of paleography or philology will often—to the average researcher or transcriber—simply look like different letters. For example, some contractions and abbreviations involve the use of a “distorted” character that symbolizes an omission of one or more additional characters; and, duplicate characters or omitted characters may be represented by one letter with another mark (such as a “superior” or a “superscript” line), or else a double letter may be represented by an entirely new character altogether, even though it is phonetically equivalent. For example, the letters “ss” and the letter “B” in German are phonetically equivalent, yet the symbol for the double letter is often a source of confusion to lay readers.

These and other obstacles lead to lower accuracy in the transcription process, meaning that the data contained within the original document is not accurately converted to an accessible digital format. For example, the word “Adam” may be transcribed as “Odum” because the person completing the transcription is not familiar with the name Adam but is familiar with the name Odum, or vice versa. Alternatively, the error could occur because of archaic character formations with regard to the capital and small letter forms of the “A”.

These obstacles also increase the economic costs of human transcription because they suggest that the persons engaged for this task must be more highly trained and must gain experience with multiple styles of handwriting and with a knowledge base associated with the subject documents. As noted, this inevitably means either higher costs or slower transcription rates and thus less accessibility to the millions of pages contained in archives and manuscript libraries around the world.

What is needed is a system, method and apparatus to permit the experience and knowledge of more highly trained persons to be available in an efficient manner to less experienced persons, so that error rates are reduced and less training is required in order to obtain a desired level of productivity and accuracy in the human transcription process; in other words, accurate transcription must be faster and less expensive so that the treasure troves of buried knowledge can become accessible to a broader public. Performing transcription work for archival collections only becomes cost-effective when undertaken on a large scale using inexpensive labor, and if the utilization of that inexpensive labor is not offset by increased technology or other costs. Most transcription projects currently underway involve only indexing the documents for key words. While this makes the collections more accessible, it does not solve the key problems associated with older collections, where the limitations of language and handwriting make them almost impenetrable except to a small group of professionals. Thus, even with a quality index, materials only become accessible to end users if those users are able to read or otherwise extract information from the underlying materials. Otherwise, in a practical sense, it becomes, as the saying goes, “an index to nowhere.” Because most libraries and archives have the dual and conflicting mandates to both preserve and protect their holdings and to increase the ability of the public to make use of them, the invention that makes both goals achievable could prove to be a “god-send” to those professionals with such mandates.

### SUMMARY OF THE INVENTION

The invention consists of a system, method and apparatus so that the experience and knowledge of one person (an “expert”) can be leveraged and made available to other persons (numerous “non-experts”) who are engaged in human transcription of documents. Using technology to bridge the knowledge gap, it allows a less-knowledgeable person to nevertheless draw on the currently unrivalled character recognition capabilities of the human brain to perform work with accuracy rates that computerized OCR technologies have been unable to achieve. The invention as disclosed here may also be used in connection with other forms of data gathering in which human interaction is required to convert information into a desired computer-accessible format. The invention's useful system involves the application of a set of principles or procedures, each of which may be adapted according to the available resources, while still acting together to produce a superior transcription outcome when compared to other existing methods or technologies.

The invention's novel system includes 1) various methods for distributing the visual content to be transcribed; 2) methods for converting the visual content to text characters that can be understood and manipulated by electronic devices to allow the application of Human Optical Character Matching; 3) methods for utilizing an apparatus to reduce costs for larger transcription projects utilizing Human Optical Character Matching; and 4) methods for manipulating and converting transcribed data to enhance its usability. Each step or method includes several embodiments, each of which involves certain advantages with attendant costs, but at its core, the invention allows for the system (being the embodiment of a variety of methods taken together) to facilitate the removal of the principal barriers to transcription of older documents at costs that are pennies on the dollar when compared to current technologies.

The invention ultimately allows the task of transcribing text to be reduced to a narrow function involving Human Optical Character Matching (HOCM), and thus the invention helps overcome and bridge the gaps in prior technologies in converting older documents and manuscripts to digital texts. Moreover, the process allows the physical tasks of keyboarding to be undertaken by a relatively unskilled labor pool, including amateurs and hobbyists, and the invention will allow for entry-level employment opportunities for workers otherwise marginalized and excluded from participating in emerging market economies. Skilled labor, on the other hand, can also be trained to serve in more technical roles to improve processes, supervise the less-skilled labor, help develop software improvements and so forth. This invention allows entry-level workers a chance to make a living without requiring large sums of startup capital (such as might be required to build factories, for example).

### DETAILED DESCRIPTION OF THE PREFERRED EMBODIMENTS

As noted above, the invention's novel system includes 1) various methods for distributing the visual content to be transcribed; 2) methods for converting the visual content to text characters that can be understood and manipulated by electronic devices to allow the application of Human Optical Character Matching; 3) methods for utilizing an apparatus to reduce costs for transcription projects utilizing Human Optical Character Matching; and 4) methods for manipulating and converting transcribed data to enhance its usability.

Image Distribution Methods—Prefered Embodiment. In the preferred embodiment, the system includes a process in which a client-server system stores scanned images of original documents centrally in a digital format on a computer server and these images, with embedded and accompanying data, are then sent via computer network to a client computer system where they appear on a screen in order to facilitate the HOCM. A user relies on a computer software application to view the document image on the screen of the client computer. Utilizing transcription software describe below, the user then marks the image with annotation points to indicate approximate line spacing, location of non-text images, and other relevant structural items. If the computer allows for touch-screen capabilities, these points may be identified by simply touching the screen with a finger or a touch pen device in appropriate places; with other computers, the annotations may be entered by clicking on the image with a mouse. These annotations will allow the image viewer to auto-scroll the image as text is entered, to return to an approximate data entry point after a particular character on the image is examined more closely using a “zoom” feature, and to respond appropriately when “line breaks” are entered. After the data point annotations are made, if the keyboard is electronic in form (whether it be touch screen or a physically separate programmable LCD or LED device), the user will load the master character set accompanying the image onto the keyboard. If the keyboard is not electronic, the user will print the master character set using the appropriate medium (described below) and apply the appropriate labels to the keys.

Image Distribution Methods—Other Embodiments. Although the preferred Image Distribution Method presumes that another step in the system has already been applied (namely the creation of the Master Character Set, described below), other embodiments of the Image Distribution Methods involve distributions that are concurrent with or precede the creation of the Master Character Set. Indeed, some access to sample images is required in order to create the Master Character Set, and for this reason it is generally described as the first step, even though the preferred embodiment above focuses on the distribution to the transcribers, rather than on the distribution that is in the form of an initial acquisition. In other embodiments, the images or the data entered by the user may be stored and transcribed on a single computer (or similarly constructed device capable of producing digital text) and transmitted either to the transcriber or to the end user of the transcribed data via a portable memory device (e.g. a flash drive or CD/DVD) rather than using a client-server or multi-computer network arrangement. This embodiment would enable the invention to be used virtually anywhere in the world, including communities with minimal literacy, as long as occasional power sources are available (including solar), and transportation is adequate to provide periodic delivery of the memory storage media.

Image Distribution Methods—Other Embodiments. In some embodiments, the data entered by the user is not stored in a corresponding relationship with the image from which it was extracted, but is stored independently. Under this embodiment, data extraction could occur directly form source materials, without the need for digital images being used. (For example, if a transcriber is allowed to photocopy or photograph adequate numbers of character samples to implement the system, the principal transcription activities could occur without needing to remove any original or duplicated images from a document's storage or preservation repository (such as archives or manuscript library). Therefore, in this implementation, the image acquisition/distribution is limited to transferring images via digital camera or via a physical medium only in sufficient quantity to be able to form a Master Character Set, described below.

Image to Text Conversion Methods (Step One—Creating a Master Character Set—Additional Background). Generally, a client computer comprises a keyboard and a viewing area. Images of original documents are displayed on the viewing area, and the keyboard is used to type the letters that are seen on the image. Traditional human transcription requires the transcriber to perform an interpretive function in the process of deciding which keys to press in order to capture the data, because keyboards do not usually contain the exact same characters as are found on a document, and a keyboard traditionally shows either an upper case (capital or majuscule) or lower case (small or minuscule) alphabetic font, but not both at the same time. The transcriber needs to remember what alternate characters look like and how to find them (such as by pressing the Shift key for the alternate version of the letter). Specialty characters often do not appear on the keyboard at all, but must be entered by inserting a symbol or a character code, such as a Unicode character number. Various levels of character complexity may be present in a document or manuscript and should thus be reflected in a Master Character File. In some simple master character files, a single character may be represented by a single image drawn from the targeted original material. Thus, the images viewed on the keyboard are to be the exact same form (font, case, etc.) as the original. In more complex master character files, a single character may be represented by a large number of images in order to more accurately correspond to variations in the manner in which a character was written (or printed) within the targeted original material. Moreover, a single character may be represented by multiple key images because of historic differences in character formation that may be understood by experts of paleography or philology but which—to lay transcribers—simply look like different letters. For example, even without regard to capitalization, a letter may take one form at the beginning of a word, another in the middle, and a third form at the end of the word. Two distinct letters may also “morph” into a new distinct form (a “ligature”), and some contractions and abbreviations involve the use of a “distorted” character that symbolizes an omission of one or more additional characters. Duplicate characters or omitted characters may be represented by one letter with another mark (such as a “superior” or a “superscript” line), or else a double letter may be represented by an entirely new character altogether, even though it is phonetically equivalent. For example, the letters “ss” and the letter “B” in German are phonetically equivalent. The invention system utilizes Human Optical Character Matching to eliminates or dramatically reduce these interpretive functions of the transcriber.

Image to Text Conversion Methods (Step One--Creating a Master Character Set—Character Duplication). As noted, creation of the Master Character Set presupposes that the creator has access to representative samples from the materials to be transcribed. (Obviously, the more pages written by the same hand, the greater return on the investment in creating this master character set as accurately and completely as possible.) The master character sets may be created using a number of methodologies:

a) In the preferred embodiment, using software that allows for characters to be “cropped” or “cut out” of the sample document and isolated from other characters, the character samples are then reproduced (and generally enlarged) to fit the size of the applicable keys. Images are generally improved by adjusting both the brightness and the contrast functions in order to allow the character to be easily readable on the keyboard, but sometimes adjustments may also include the removal of other blemishes or discolorations or of portions of adjacent letters that could not be removed through cropping. Each character contained in the document should be created separately and stored in the appropriate manner for the embodiment for which it will be deployed. For example, after acquiring, cropping and correcting a small letter g from the document, the new character is labeled and saved as a .jpg file that can be imported into a digital keyboard, subsequently printed in a label maker, converted to vector art for creation of a keyboard overlay, or else added to a page of images to be printed and cut out separately as one half inch square letters for manual relabeling of a keyboard. If the same document contains another variation of the letter g that is sufficiently dissimilar that it could not be readily matched by a human as being the same character as the first letter g, then a character for the variation is also created, etc. This process is repeated until each character is duplicated and added to the Master Character Set. The data within the master character set need not and generally cannot (except with printed works) correspond precisely to all of the images of characters within the documents that are being viewed or transcribed, because human scribes are seldom capable of such consistency in hand-writing. Rather, it will often be the case that the master character file will include the most common or most likely version of a handwritten character (or, with the aid of image manipulation software, the average character shape as determined from multiple overlapping samples) in a manner that will enable the user to make an informed choice regarding which character appears within the document and select the closest corresponding programmable key, with duplicate variations of a letter only used if a character cannot otherwise be reasonably matched. However, multiple image elements may comprise a series of different images within the subject document corpus, all of which correspond to the same encoded character on a keyboard, but under circumstances where the keyboard cannot accommodate multiple variations of the same letter. Thus, in some embodiments, the user may have the ability to switch between multiple image elements within a master character file in order to display an image on a programmable key that more closely resembles a character within the document being transcribed. In other words, if a character on a document resembles a character on the keyboard but is not close enough to assure reasonable certainty, the transcriber may examine known variations of the character on an electronic or on a printed letter sample “cheat sheet”. Whereas some advanced electronic keyboards allow a user to hover over a character to bring up variations (such as hovering over the letter “a” to see variations that including various accents, or a diaeresis, or tilde, etc.), in this embodiment, the hover over function would reveal variations on the same Unicode character drawn from the handwriting sample, because the other Unicode characters likely to be encountered would already be separately displayed on the keyboard. Unidentifiable or significantly distinctive variations of a character should be flagged for review and possible inclusion as variations in the master character file.

b) In another embodiment, the character duplication occurs by simply sizing a photocopy of the characters from a document collection and manually cutting out the applicable characters to allow them to be manually attached to the keys of a keyboard. This lower-tech solution allows non-programmable keyboards to be re-purposed by relabeling existing keys without the use of image-manipulating software, but would also likely require the simultaneous use of a second keyboard (at least) in order to accommodate the visual display all of the character variations, with one keyboard left permanently in the “shift” mode.

c) As an additional step, another embodiment involves converting the rasterized images into a vector art format, and then utilizing software to create a complete, customized character font to match the text or handwriting in the sample. As with rasterized images, these vector art images may be printed or displayed directly on a programmable keyboard, including an LED screen, but the creation of a functional font that matches the source document also allows the transcriber to import the font into a word processing program so that the transcriber can subsequently see a copy of the transcription that closely approximates the original.

d) Regardless of the variation used, each embodiment of the Master Character File should include the availability of a special character or key that serves as a “flagged placeholder” representing a letter or character that the transcriber cannot identify or match with existing keys, so that additional attention may be drawn to that character later on (hopefully with specialized assistance or by applying various “tool kits” described below). Generally, the flagged placeholder should not be simply a question mark or an underlined space left blank, because these characters might be utilized for their normal purposes elsewhere in the document and could create confusion when utilizing a search function to retrieve the instances with unknown characters, but most document sets don't utilize the full range of symbols in most keyboard fonts, so a placeholder symbol could be coded to lesser-used characters such as a straight line (“|”) or an up arrow (“̂”) for the underlying font, unless the documents involve specialized math equations, and so forth.

Image to Text Conversion Methods (Step Two—Character Value Assignment). As noted above, the preferred keyboard embodiment comprises multiple keys that are programmable and contains either enough keys to display all of the characters likely to be encountered in the document collection or else may accommodate additional keyboards. As also noted, the master character file may be in any suitable format and may have any suitable structure appropriate to the hardware being utilized. But in the preferred embodiment, the master character file is structured as a set of data pairs where the first element of each pair contains one or more bitmapped (or similar, such the more memory-friendly.jpg) images in varying resolutions and the second element of each pair contains an encoded (e.g. Unicode) character that corresponds to the image data within the first element. When the embodiment of the master character file is electronic, the master character file may be stored on the client computer or may be transmitted to the client computer from a server computer or other remote location based on the structure of the overall transcription project. Thus, in one embodiment, a master character file is embedded within or otherwise permanently associated and transmitted with the image data of a document to be transcribed. In this embodiment, a specialized All-In-One image format is used that contains an image of the document to be transcribed and also includes the data comprising the master character file. When the computer software application that manages the human transcription process operates on an All-In-One file that uses this specialized image format, the computer software application extracts the document image for display on the screen, and also extracts the master character file data and promptly configures the programmable keys within the keyboard to display the data within that master character file, and the master character file can be set to “auto update” when changes to the master character set are made, for example when a new character is added. For programmable keyboards that require printing physical labels, the master character file would come “print ready” with respect to the applicable print medium, with additions coming as separate print ready files. When using the All-In-One image format, each file becomes a “stand-alone” project that can be operated on by a user without the need for further data or instructions, although updates are possible. This embodiment may be advantageous where computer network connectivity does not permit continuous or stable connections between computers, or when the file is transmitted via external memory devices. An image file in the All-In-One image format may be generated using a software application that permits a skilled operator to first construct a master character file and then conveniently permits that operator to associate that master character file with a set of multiple document images. The software application then creates the corresponding All-In-One image files using the document image and the corresponding master character file.

Using Apparatus to Improve Functionality. In embodiments that do not allow for the use of an electronic, programmable keyboard with an All-In-One image format, character value assignments may need to be applied manually, or in some instances, by running software “macros” to perform customized search and replace functions after the transcription project has been completed. Manual assignment involves programming the keyboard to display a symbol or character on the screen that corresponds to the graphical image on the key. In some embodiments, this may involve programming the keyboard to display a small g whenever the key containing the handwritten image of the g is pressed, but it may also involve programming the keyboard to perform a macro containing a number of keystrokes in order to display the proper character on the screen. However, in some instances, a document may contain a symbol for which no existing Unicode character exists, such as a ligature unique to the author of the document. Thus, the Master Character File may contain symbols that cannot be assigned a known value. In this case, the programmer must either decide to program the keyboard to display a copy of the original image itself when the applicable key is pressed (e.g. leaving that specific symbol un-transcribed), or program the keyboard to display alternate characters to approximate the meaning of the symbol. For example, if the author of a given text uses a symbol to represent the letter combination of “er” when it occurs at the end of a word and that symbol is not in any existing Unicode or other character sets, the keyboard can be programmed to either display the symbol in graphic form, display a substitute character to be replaced later, or to display the letters as if each had been typed separately, or a combination of these options. The transcriber need not have any knowledge of what the symbol represents, because—as noted above—Human Optical Character Matching does not require that the transcriber has to recognized the symbol's meaning. However, in instances where the items appearing on the screen are sufficiently different than what the transcriber might expect from pressing a key, the transcriber may be given “notice” to expect something different by color-coding the keyboard keys.

Although the invention allows flexibility in its variety of uses, and in particular, the variety of keyboards that may be adapted for use with the system, including programmable and non-programmable keyboards, or even a touch-screen variety, a transcription-specific keyboard may also be constructed so that each programmable key contains a small display, such as a liquid crystal display (LCD). In one embodiment, such an LCD placed on the top portion of each programmable key provides a display resolution of approximately 10×20 pixels; in another embodiment, it provides a display resolution of approximately 25×50 pixels. Other display resolutions are also comprised within the invention, including the possibility of having each key be customized to the desired resolution or having the entire keyboard be comprised of one touch screen divided into separate keys only graphically, but unlike touch screen monitors, the keyboard is specifically designed to lay flat. This touch-sensitive display-based keyboard would allow sorting of character groupings pulled from the Master Character Set by drag and drop functions (with locked-position functions also available) so that display preferences could be updated by end users “on the fly” over the course of a transcription project.

Because a principal function of the invention is to allow technology to bridge the knowledge gap, experts are able to focus more on the higher value work of research and analysis, while non-experts can perform fill the role of what technology has enabled to become data entry through Human Optical Character Matching. The “keys” to this transformation in its most cost-effective embodiment lie in the system for creating the master character set and then displaying them on a keyboard that allows them to be easily located by the non-expert. In other words, the keys to the best transformation are both literally and metaphorically on the keyboard, because it is what allows the non-expert to specialize in performing one principal task extremely well: matching individual character symbols on the screen or page with individual character symbols on the keyboard. A keyboard that is designed in a way that it presumes the transcriber has no other knowledge or ability other than Human Optical Character Matching (not the more advanced cognitive functions of recognition) will allow one person with expert recognition ability to leverage that knowledge to enable work to be performed by thousands who have (initially, at least) only matching abilities. Conventional keyboard layouts were designed in the late 19^{th} century to facilitate speed based on the anticipated use of certain characters, the anticipated motions of the fingers and the likelihood that the keys would jam in a manual typewriter. While typewriter jams are long gone technologically, the basic keyboard layout was so thoroughly and universally adopted and converted for computer use that it remains the defacto standard for typing early in the 20 century. Unfortunately, such a layout is not conducive to either speed or accuracy in transcribing unrecognizable characters. In fact, the layout actually causes mental “jams” for the non-expert users. An alternate layout that organizes characters alphabetically might be useful for some users who are at least able to determine basic character shapes, but are not yet experienced with a QWERTY keyboard layout. However, the recognition errors for non-experts still remain a significant problem in transcription when the subtle differences between letters could be mere jots and tittles such that—unless the two characters are literally side by side—they are so frequently confused that whether the transcriber gets the character right is a matter of mere chance.

Because the anticipated users of the invention include transcribers with little or no expertise with regard to the characters, words, language or subject matter, the character layout and configuration on the keyboard is designed to facilitate Human Optical Character Matching, and not to specifically facilitate original authorship of any texts. Accordingly, the preferred embodiment is for the characters to be arranged in groupings determined by principally by similarities of shape or by a principal distinguishing feature, rather than grouping according to any preconception of where a certain letter would expected to be found on a keyboard under any prior art. Indeed, the specific layout would be designed for the specific characters found in a document collection, and because of variances in character formations, a character found in one configuration for one project may be in a different spot for another, and when a specific character displays two dominant features, it may appear in two locations simultaneously to facilitate ease of use. (When a character appears in two locations, one embodiment allows for a color coded key to identify that it has a twin somewhere else on the keyboard, so as to prevent the transcriber from agonizing over potential differences that do not exist). The groupings in one embodiment might include all characters with diacritical marks appearing above a letter (such as an accent or grave or diaeresis) appearing at the top of the keyboard, and characters with diacritical marks appearing below a letter (such as un underbar or subscript curl) might appear at the bottom of the keyboard. Letters comprised of circular shapes (such as a cursive “a” or “o” or an “e” in some scripts) might be clustered to the left, while letters comprised of high loops might be to the right, letters with low loops might appear below them, and letters that are small and bumpy or jagged (such as “m” or “n” or a cursive “r” or a cursive “e” in old German script) might be grouped below the circular shapes. In the preferred embodiment, the placement of individual characters within the groupings, and the placement of the groupings themselves on the keyboard overall will be influenced by the perceived frequency of use of the characters or groups of characters. For example, if a random sampling suggests that a certain vowel is likely to have 15% occurrence in the document, when other characters appear less frequently, then for a user who is accustomed to reading from left to right and from top to bottom, the most frequently used character might appear in the top left corner of the keyboard. On the other hand, if ergonomics are taken into consideration, it might appear on the keyboard most conducive to comfort of use. A transcriber accustomed to reading from right to left, on the other hand, might have a character layout that is the inverse of the layout described above. Because the ability to spot and match a character is of premium importance, and because having a broad field of view of the keyboard is thus important, keyboard layouts that encourage a user to leave their hands hovering over the keyboard (and thus blocking the view of the characters) are discouraged until a user had more or less memorized (through frequency of use) the placement and subtle differences of the characters, which would only be possible for larger and mostly homogenous transcription projects.

Data Manipulation and Transcription Enhancement Tools. Tools and enhancements are most useful for projects under two scenarios: small projects that aren't utilizing preferred embodiments, and larger projects that are. On the small end of the scale, where an implementation may involve in its simplest form the relabeling of two non-programmable keyboards, the variety of pre-programmed characters would probably not accommodate all of the characters found in the document. Under such circumstances a key may be relabeled to represent a character bearing no correlation to what the keyboard has been programmed to display. Thus, a key may be labeled to represent a letter with an accent, when the character appearing on the screen might be an equal sign. Under such circumstances, after the data has been transcribed, corrections could be made by running correction macros in the word processing software, or else by manually running a series of “search and replace” functions for each character as needed. Though such data manipulation may be simple by itself, it actually enables the use of any two keyboards (with one left in shift mode, as noted above) to be adapted for use with the invention to facilitate Human Optical Character Matching without requiring any outlay of funds for anything beyond the most rudimentary computer equipment. For larger projects, on the other hand, whether a capital outlay is justified, the tools and enhancements may be much more advanced to facilitate greater accuracy in character matching and greater usability of the transcribed material.

In the preferred embodiment, the enhancement features and tools include the following:
1. Software that automatically compiles each transcribed word into a document index and into a usage dictionary so that spelling and word usage variations may be tracked and analyzed.
2. Software that automatically tracks character usage frequency.
3. Software that allows the creator of the Master Character Set, or a subsequent helper, to identify the pen strokes involved in the formation of each character that allows the strokes to be displayed on request of the user in order to help match problematic characters.
4. Software that allows a transcriber to simulate (via tracing on a touch screen, tablet or pad, or mouse) the approximate strokes of an unknown character so that the software can help prompt the user regarding possible matches for that character, or that can flag a character for possible inclusion in a Master Character Set.
5. Software that compares the words in a transcribed text to other known variations in spelling and usage and helps flag unique variations for further examination, and when applicable, helps prompt transcribers regarding possible options for otherwise unidentified characters. Unlike traditional dictionaries and grammar tools, this tool does not seek to encourage the user to harmonize the usage with an outside standard, but seeks only to assist the transcriber in transcribing the text as true to its original form as possible.
6. Software that flags for additional review (or possible expert arbitration) character differences when the same or similar texts or characters are transcribed differently.
7. Software that helps identify whether the handwriting or print font in a document or manuscript is the same as or substantially similar to a Master Character Set already compiled.
8. Software that allows the All-In-One image format to also provide the ability to store a variety of information related to a transcription project, such as identifying information about the transcriber, dates, etc., as well as historical information such as the source of the image, dates, authorship, and aids to understanding content.
9. Software that allows a transcriber to cut and paste a picture or other graphic representation found within the image from which the transcribed text is taken, so that it remains associated with the text in the final transcription.
10. Software that converts the Human Optical Character Matching activity with respect to handwritten characters into a game, with users earning points or reward units to encourage consistent participation.

In summary, as noted in greater detail throughout the descriptions above, these embodiments of the invention provide many advantages over the prior art. Among other advantages:
1. Workers who have very little knowledge of the background, context, or language of the subject documents are able to nevertheless transcribe the documents because the transcription is reduced to a process of matching images between a programmable or relabeled key and an on-screen image of a document.
2. Costs of transcribing valuable documents can be reduced because workers with lower skill levels may be used, and the time involved for even skilled labor may be reduced for certain projects.
3. Digital computers and worldwide networks may be used to distribute transcription work among a large number of workers. Individuals may use the All-In-One image format to complete work even when network connectivity is intermittent or unavailable.
4. Workers who are entirely unfamiliar with the language used within a document are enabled to transcribe the document merely by matching images on the programmable keys to the document image. For example, in this manner an English speaker could transcribe a Korean language document, and a Vietnamese speaker could transcribe an English language document. Moreover, even otherwise “dead languages” like Sanskrit could be transcribed and become accessible.
5. Where needed, software prompts may appear to enable the transcriber to examine whether an otherwise unrecognizable character could be a certain character expected to be there, such as by a dictionary reference.

What is claimed is:

1. An apparatus comprising a computer keyboard that can be relabeled to display on its keys any number of different characters.

2. An apparatus according to claim 1 in which the computer keyboard comprises multiple keys each having the ability to display a character image thereon.

3. An apparatus according to claim 2 in which the relabeling action is accomplished via software programming instructions that display on the keys of the keyboard any number of different character images.

4. An apparatus according to claim 2 in which the character image appearing on a keyboard key can be re-configured through data that is downloaded to the computer keyboard via a standard computer connection.

5. Computer software comprising a means of creating an image of multiple characters on a touch-sensitive display screen, where the image of the characters may be reconfigured through the computer software so as to display different characters.

6. Computer software according to claim 5 further comprising a means of creating an image of a keyboard having programmable keys within a touch-sensitive display device.

7. A method of extracting data from a handwritten or typed document comprising the steps of
a. Providing a computerized device having a keyboard comprising programmable keys;
b. Providing a data file comprising a digital image of the handwritten or typed document;
c. Programming the programmable keys to display images such that the image on each programmable key substantially resembles a character within the handwritten or typed document;
d. Presenting the image of the handwritten document to a user;
e. Collecting data from the user via the keyboard indicating a series of selections on the programmable keys;

8. The method of claim 7 in which the series of selections on the programmable keys is stored in a manner that corresponds to the data file comprising the digital image of the handwritten or typed document.
